(19) United States
(12) Patent Application Publication
(10) Pub. No.: US 2022/0166278 A1
(43) Pub. Date: May 26, 2022

(54) STATOR WITH WIRE GUIDING INSULATOR

(71) Applicant: NIDEC Motors & Actuators (Germany) GmbH, Bietigheim-Bissingen (DE)

(72) Inventors: Kosuke OGAWA, Stuttgart (DE); Tomoyuki UMEDA, Stuttgart (DE)

(21) Appl. No.: 17/534,689

(22) Filed: Nov. 24, 2021

(30) Foreign Application Priority Data
Nov. 26, 2020 (DE) 102020131418.3

(51) Int. Cl. H02K 3/52; H02K 15/095

(52) U.S. Cl. CPC H02K 3/522; H02K 2203/09; H02K 2203/12; H02K 15/095

(57) ABSTRACT

A stator includes a stator core with stator teeth, each of which is at least partially surrounded by an insulator which includes a winding chamber with a winding space. The winding space is bounded on an inner side by an inner flange and on an outer side by an outer flange. The stator includes coils wound around the insulators in the winding space, the windings of the coils being defined by a winding wire including a first winding wire end portion on one side of the winding wire and a second winding wire end portion on another side of the winding wire. The outer flange of the insulator includes a first recess, and a second recess, which is on the end surface on the inner side and into which in each case one of the two winding wire end sections is inserted.

### CROSS REFERENCE TO RELATED APPLICATION

The present application claims priority under 35 U.S.C. § 119 to German Application No. 10 2020 131 418.3, filed on Nov. 26, 2020, the entire contents of which are hereby incorporated herein by reference.

### 1. Field of the Invention

The present disclosure relates to a stator, as well as to a brushless electric motor including a stator and to a method of winding a stator tooth of a stator of a brushless electric motor.

### 2. Background

A brushless electric motor as a three-phase electric machine has a stator with a number of stator teeth arranged, for example, in a star shape, each of which is enclosed by an insulator around which an electric stator winding is wound in each case. In conventional windings, the wire ends usually extend to the left and right at the outer end of the stator tooth. This has the disadvantage that the wire ends are always close to those of the neighboring tooth. The coils are associated with the coil ends of individual strands and are interconnected in a predetermined manner by common connecting conductors. In the case of a brushless electric motor as a three-phase machine, the stator has three strands and thus at least three connecting conductors to which electric current is applied in a phase-shifted manner in each case in order to generate a rotating magnetic field in which a rotor or armature, which is usually provided with permanent magnets, rotates. The connecting conductors are fed to a motor electronics unit to control the electric motor. The coils of the stator winding are interconnected in a certain way by means of the connecting conductors. The type of interconnection is determined by the winding scheme of the stator winding, whereby a star connection or a delta connection of the coils is usual as a winding scheme.

It is known to use the connecting conductors in the form of a busbar assembly. The busbar assembly includes busbars which are connected with their end sections on one side to the winding wires of the coil groups respectively and on the other side each have an external connection terminal for electrical connection to a control unit.

### SUMMARY

Example embodiments of the present disclosure provide stators each of which is simple to manufacture, able to be automated, and includes a structure that facilitates the construction of a busbar assembly.

Example embodiments of the present disclosure also provide stators, electric motors with stators, and methods for winding stator teeth of stators of brushless electric motors.

An example embodiment of a stator according to the present disclosure includes a rotationally symmetrical stator core including stator teeth each at least partially surrounded by an insulator including a winding chamber with a winding space, the winding space being bounded on an inner side by an inner flange and on an outer side by an outer flange. The stator includes coils wound around the insulators in the winding chamber, the windings of which include a winding wire including a first winding wire end portion on one side of the winding wire and a second winding wire end portion on the other side of the winding wire. The outer flange of the insulator includes a first penetrating recess (aperture) introduced from an end surface and a second recess on the inner surface, into each of which one of the two winding wire end sections is inserted. The recesses extend with their longitudinal axes parallel to the longitudinal axis of the stator from the end surface of the insulator and the first penetrating recess is located centrally of the stator tooth in the circumferential direction relative to a central axis of the stator and the second recess is located in a lateral end region of the outer flange in the circumferential direction. Preferably, the second recess projects into the outer flange only from the inner side and does not penetrate the outer flange. In other words, the second recess is groove-shaped.

The winding wire end section is preferably fixed in the second recess, in particular pressed in or clipped in. The winding wire end preferably extends in the longitudinal direction (parallel to the longitudinal axis of the stator) in the region of the second recess.

The winding wire end section may be fixed in the first recess, but does not have to be.

The longitudinal axis of the stator corresponds to the axis of symmetry and central axis as well as the axis of rotation of the rotor of the electric motor in which the stator is mountable. Furthermore, with respect to the central axis or the longitudinal axis, a radial direction is referred to, which indicates the distance from the central axis, and a circumferential direction is referred to, which is defined tangentially to a certain radius extending in the radial direction.

Since, according to a preferred embodiment of the present disclosure, both end portions of the winding wire are held and positioned in the insulator, a busbar assembly can be easily contacted therewith. In addition, the winding is prevented from getting slack. In addition, the distance between the two winding wire end portions is particularly large in the circumferential direction, which has advantages for contacting.

Preferably, each stator tooth includes an elongated tooth body and a tooth root adjoining it at one radial end and a tooth tip adjoining it at another radial end. The insulator surrounds the tooth body and at least partially surrounds the tooth tip and the tooth root. The recesses extend with their longitudinal axes parallel to the longitudinal axis of the stator from the surface of the insulator to a height corresponding approximately to the top of the tooth body. The recesses are thus long enough to securely receive the winding wire end portions. It is advantageous if the second recess is approximately circular in cross-section with an opening to permit insertion of the wire and the wire is clipped or pressed into the recess, thus providing a secure positive attachment.

In an example embodiment of the present disclosure, a first one of the two winding wire end portions is inserted into the first recess and the tooth body is wound around starting from the second recess in a radial direction from the outside to the inside and back from the inside to the outside, with a second one of the two winding wire end portions inserted into the second recess.

Preferably, the lateral end of the outer flange adjacent to the second recess defines a radially inwardly projecting projection adjacent to the underside of the recess, which projection defines the winding space in the circumferential direction for the second winding wire end portion and thus secures the position of the second winding wire end portion during the winding process.

In order to improve contacting with a busbar assembly, it is advantageous if the winding wire ends of the winding wire end sections of each stator tooth protrude over the insulator at the end surface (top).

It is preferred that the distance between the two winding wire ends of a stator tooth in the circumferential direction is at least about 40% of the total width of the outer flange in the circumferential direction. In particular, the spacing is selected such that the spacing of consecutive winding wire ends of the stator in the circumferential direction is constant or substantially constant.

Furthermore, an electric motor includes a rotor which is mounted rotatably about an axis of rotation, the rotor being surrounded externally by a previously described stator. Preferably, the winding wire ends are electrically contacted at the end surface with a busbar assembly, the contacts of which are evenly spaced in the circumferential direction. Such a busbar assembly is particularly easy to manufacture and can be automatically placed on the stator.

In addition, a method is provided to wind a stator tooth of a stator of a brushless electric motor, the stator tooth being at least partially surrounded by an insulator which includes a winding chamber with a winding space, the winding space being bounded on an inner side by an inner flange and on an outer side by an outer flange. The outer flange of the insulator includes a first penetrating recess introduced from the end surface and a second recess on an inside with their longitudinal axes parallel to the longitudinal axis of the stator tooth from the end surface of the insulator, the first recess being located centrally of the stator tooth in the circumferential direction with respect to the longitudinal axis of the stator tooth and the second recess being located in a lateral end region of the outer flange in the circumferential direction. The method includes inserting a first winding wire end portion of a winding wire into the first recess, the winding wire end portion passing through the outer flange and being at an angle to the longitudinal axis of the stator, preferably between about 100° and about 60°, guiding the winding wire away from the second recess and around the insulator defining a winding direction, wrapping the stator tooth in the direction from the outer flange to the inner flange and back while maintaining the winding direction, inserting and fixing a second winding wire end portion of the winding wire opposite the first winding wire end portion into the second recess, the winding wire end portion lies in the second recess parallel to the longitudinal axis of the stator, and aligning the first winding wire end portion parallel to the second winding wire end portion.

The winding process is particularly simple and can be automated due to the defined position of the winding wire end sections. Since the first winding wire end section is only aligned parallel to the longitudinal axis of the stator at the end of the process, there is more space for the winding process and the winding tool can get past the first winding wire end much better.

Preferably, the lateral end of the outer flange adjacent to the underside of the recess provides a projection projecting inwardly in the radial direction, past which the winding wire is guided internally in the wrapping, so that the projection defines the position of the second winding wire end portion outwardly to perform the inserting and fixing and prevents the second winding wire end portion from slipping outwardly. For further preferred features of the stator tooth, please refer to the preceding description of the stator.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 is a spatial view of a stator tooth with a first winding wire end inserted into an insulator according to an example embodiment of the present disclosure.

FIG. 2 is a spatial view of the wound stator tooth with first and second winding wire ends.

FIG. 3 is a spatial view of the wound stator tooth with first and second winding wire ends inserted.

FIG. 4 is a spatial view of the wound stator tooth in its final state.

FIG. 5 is a spatial view of a stator having a plurality of stator teeth and a bus bar assembly.

### DETAILED DESCRIPTION

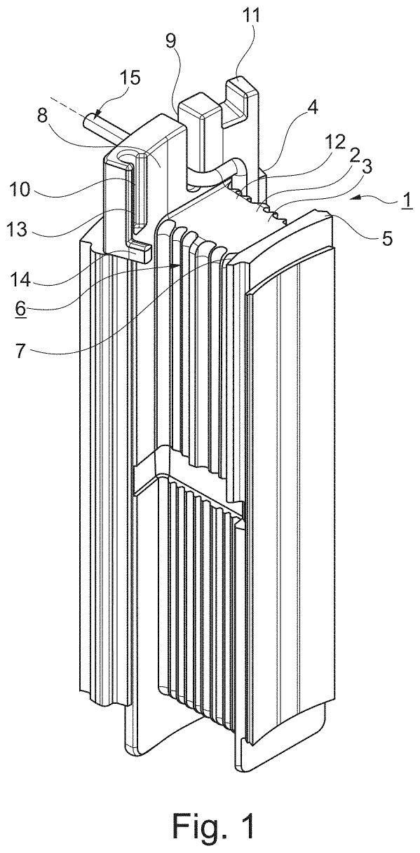

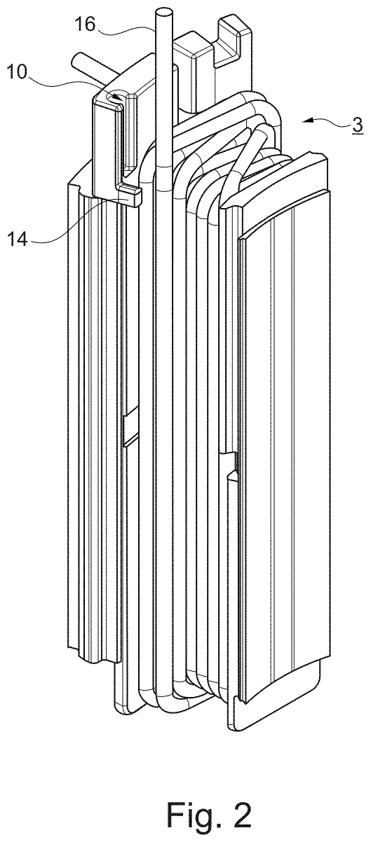

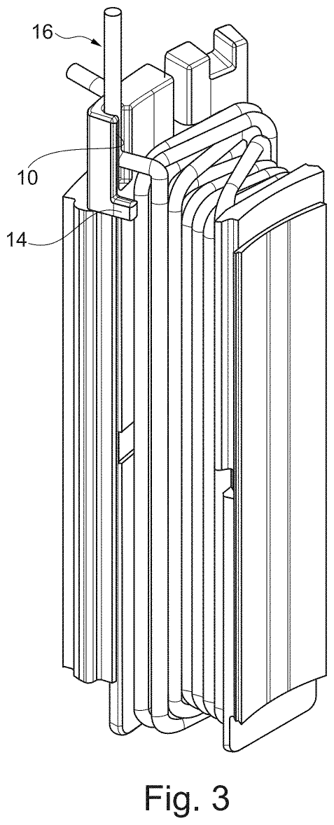

FIG. 1 shows a stator tooth 1 with an insulator 2 which insulates the winding, which is not shown, from the stator tooth 1. Each stator tooth 1 has an elongate tooth body 3 and a tooth root 4 adjoining it at one radial end and a tooth tip 5 adjoining it at the other end. The tooth root 4 is wider than the tooth head 5 in the circumferential direction with respect to the longitudinal axis of the stator, and is on the outside in the radial direction. The insulator 2 surrounds the tooth body 3, the tooth head 5, as well as parts of the tooth base 4. The insulator 2 has a winding chamber 6 in each case, which is wound by a winding wire not shown. The winding chamber 6 has a winding space which, in the radial direction with respect to the longitudinal axis of the stator, is bounded on the inside by an inner flange 7 and on the outside by an outer flange 8. The outer flange 8 has, at the top of the end surface, a slot-like first recess 9 passing through the outer flange and a second groove-like recess 10 located on the inside, which recesses are provided for guiding and fixing the winding wire end sections which are not shown. The recesses 9,10 extend with their longitudinal axes parallel to the longitudinal axis of the stator from the end surface of the insulator 11 to a height corresponding approximately to the top face of the tooth body 12. The first recess 9 is located centrally of the tooth body 3 in the circumferential direction with respect to the longitudinal axis of the stator. In other words, the first recess 9 lies on a plane of symmetry of the stator tooth 1. The second recess 10 is approximately circular in cross-section with an opening 13 for insertion of the wire. In the axial direction, the second recess lies at the same level as the first recess 9. In the circumferential direction, the second recess 10 lies in an end region of the tooth root. In the case illustrated, the second recess 10 is located to the left of the first recess 9 in plan view of the inner side of the outer flange 8. The left end of the outer flange 8, which delimits the second recess 10 on the left side, forms a protrusion 14 projecting inwards in the radial direction adjacent to the underside of the recess 10 at a height of the tooth body. This protrusion 14 serves to guide the wire during the winding process. A first winding wire end portion 15 passes through the first recess 9. Preferably, the winding wire end portion 15 is fixed, in particular clipped, in the first recess. However, a slight overlap between the winding wire end portion 15 and the side walls of the recess 9 may be provided, as well as a minimal clearance. The first winding wire end portion 15 extends at an angle to the longitudinal axis of the stator, preferably between 100° and 60°, and is then guided clockwise, away from the second recess 10, around the tooth body 3. By inserting the winding wire at an angle to the longitudinal axis of the stator, the winding tool can be better guided past the first winding wire end portion. Winding is performed in the radial direction from the outside to the inside and back from the inside to the outside until the condition shown in FIG. 2 is reached. The second winding wire end portion 16 of the same wire is located on the outside left of the tooth body 3 at the end of the winding process. The protrusion 14 of the tooth base limits the position of the second winding wire end portion 16 laterally to the left and prevents the winding wire from slipping. In a final step, the second winding wire end portion 16 is pressed radially outwardly into the second recess 10, where it is fixed in position, as shown in FIG. 3.

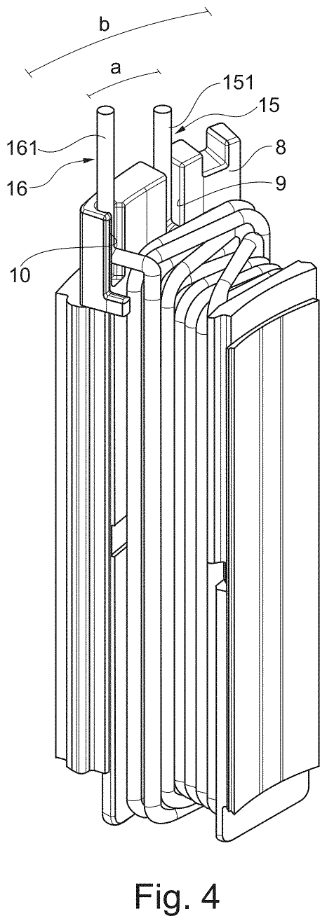

FIG. 4 shows the final state of the winding process. The first winding wire end portion 15 is bent upward so that the winding wire end portion extends parallel to the longitudinal axis of the stator. The winding wire ends 151,161 of the winding wire end portions 15,16 project upwardly from the end surface of the outer flange of the insulator 8 in the longitudinal direction of the stator. The winding wire ends 151,161 have a fixed distance a between them. The distance a between the two winding wire ends in the circumferential direction is at least 40% of the total width b of the outer flange in the circumferential direction. In this case, the outer flange 8 has approximately the width of the tooth root not shown. The distance to the ends of the adjacent teeth, which is not shown, is also approximately equal to the distance a. The distance between the contacts in the circumferential direction of the stator is thus constant, which significantly simplifies the assembly of a busbar assembly, in particular the welding process. Moreover, since the wire ends are positively held in the recesses 9, 10, in particular clipped or pressed in, the position of the ends 151, 161 is clearly defined for the assembly and the winding cannot get any play.

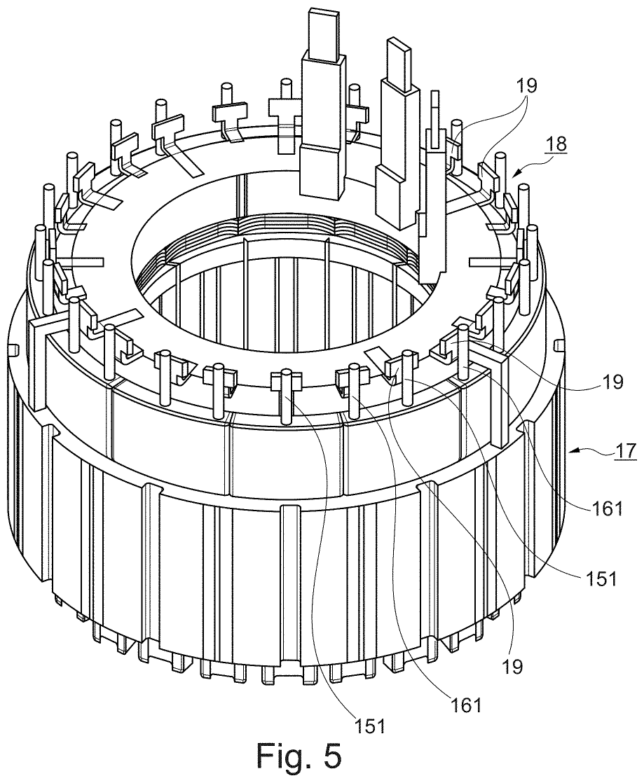

FIG. 5 shows an arrangement of a stator 17 with a busbar assembly 18 mounted on the top. The contacts of the busbar assembly 19 are all evenly spaced in the circumferential direction. Contacting with the winding wire ends 151,161 has not yet taken place in the example shown. In a next process, the winding wire ends 151,161 are welded to the contacts of the busbar assembly 19 in a fully automated manner, which is possible due to the spacing and position of the winding wire ends 151,161 on a common side of the stator. The exact positioning of the winding wire ends also ensures that they are aligned parallel to the longitudinal axis and are firmly in a defined position, which greatly simplifies assembly.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator, comprising:
a rotationally symmetrical stator core with stator teeth;
and insulator at least partially surrounding each of the teeth, the insulator including a winding chamber with a winding space which is bounded on an inner side by an inner flange and on an outer side by an outer flange; and
coils wound around the insulator in the winding space, windings of the coils being defined by a winding wire including a first winding wire end portion on one side of the winding wire and a second winding wire end portion on another side of the winding wire; wherein
the outer flange of the insulator includes a first recess which is introduced from an end surface of the insulator and extends therethrough, and a second recess which is located on an inner side on the end surface, and each of the first winding wire end portion and the second winding wire end portion being inserted in the first and second recesses;
the first recess and the second recess extend with their longitudinal axes parallel to a longitudinal axis of the stator from the end surface of the insulator and the first recess is located centrally with respect to the stator tooth in a peripheral direction with respect to a central axis of the stator and the second recess is located in a lateral end region of the outer flange in a circumferential direction.

2. The stator according to claim 1, wherein
each of the teeth include an elongated tooth body and a tooth root at one radial end and a tooth head at another radial end;
the insulator surrounds the tooth body and at least partially surrounds the tooth head and the tooth root; and
the first recess and the second recess extend with longitudinal axes parallel to the longitudinal axis of the stator from a front surface of the insulator to a height which approximately corresponds to a height of an upper side of the tooth body.

3. The stator according to claim 1, wherein
the second recess is approximately circular in cross-section with an opening permitting the insertion of the winding wire and the winding wire being clipped into a corresponding one of the first and second recesses.

4. The stator according to claim 1, wherein
the first winding wire end section is inserted into the first recess and the tooth body is wound around an outside away from the second recess and in a radial direction from the outside to an inside and back from the inside to the outside and the second winding wire end section is inserted into the second recess.

5. The stator according to claim 1, wherein
the lateral end of the outer flange is adjacent to the second recess adjacent to a bottom of the recess and defines a projection projecting inwardly in a radial direction, which limits the winding space in the circumferential direction for the second winding wire end section.

6. The stator according to claim 1, wherein the first winding wire end portion and the second winding wire end portion of each stator tooth includes a winding wire end which projects upwards beyond the insulator at the end surface of the insulator.

7. The stator according to claim 1, wherein a distance between the first winding wire end portion and the second winding wire end portion in the circumferential direction is at least about 40% of a total width of the outer flange in the circumferential direction.

8. The stator according to claim 1, wherein a distance between circumferentially successive winding wire ends (of the stator is constant or substantially constant.

9. An electric motor, comprising:
a rotor mounted to rotate about an axis of rotation; and
the stator according to claim 1 surrounding the rotor externally.

10. The electric motor according to claim 9, wherein
winding wire ends are electrically contacted at the end surface of the insulator with a busbar assembly, contacts of which being uniformly or substantially uniformly spaced in the circumferential direction.

11. A method of winding a coil around a stator tooth of a stator of a brushless electric motor, the stator tooth being at least partially surrounded by an insulator which includes a winding chamber with a winding space, the winding space being bounded on an inner side by an inner flange and on an outer side by an outer flange, wherein the outer flange of the insulator includes a first penetrating recess defined from the front surface, and a second recess on the inner side at an end surface, the first recess and the second recess extend with longitudinal axes parallel to a longitudinal axis of the stator tooth from the end surface, the first recess being located centrally with respect to the stator tooth in a circumferential direction relative to the longitudinal axis of the stator tooth and the second recess being located in a lateral end of the outer flange in the circumferential direction, and the method comprising:
a) inserting a first winding wire end portion of a winding wire into the first recess, the winding wire end portion passing through the outer flange and being at an angle to the longitudinal axis of the stator, preferably between about 100° and about 60°;
b) leading the winding wire away from the second recess and around the insulator defining a winding direction;
c) winding the winding wire around the stator tooth in a direction from the outer flange to the inner flange and back while maintaining the winding direction;
d) inserting and fixing a second winding wire end portion of the winding wire opposite the first winding wire end portion into the second recess; and
e) aligning the first winding wire end section parallel to the second winding wire end section.

12. The method according to claim 11, wherein
the lateral end of the outer flange adjacent to the second recess defines a projection adjacent to an underside of the recess, projecting inwardly in a direction along the inner flange, the projection is passed on an inside by the winding wire in step c), so that the projection defines a position of the second winding wire end portion outwardly to carry out step d).
